(19) United States
(12) Patent Application Publication
(10) Pub. No.: US 2026/0205824 A1
(43) Pub. Date: Jul. 16, 2026

(54) CONTROL DEVICE FOR CONTROLLING RADIO RESOURCE IN O-RAN, PROCESSING DEVICE, CONTROL METHOD, PROCESSING METHOD, AND NON-TRANSITORY COMPUTER-READABLE-STORAGE MEDIUM

(71) Applicant: KDDI CORPORATION, Tokyo (JP)

(72) Inventors: Masaki SAGARA, Tokyo (JP); Kazuya MORIWAKI, Tokyo (JP); Masaya SHIBAYAMA, Tokyo (JP); Shinobu NANBA, Tokyo (JP)

(21) Appl. No.: 19/563,167

(22) Filed: Mar. 11, 2026

Related U.S. Application Data
(63) Continuation of application No. PCT/JP2024/035272, filed on Oct. 2, 2024.

(30) Foreign Application Priority Data
Oct. 13, 2023 (JP) 2023-177740
Mar. 6, 2024 (JP) 2024-034151

(51) Int. Cl. H04W 16/10

(52) U.S. Cl. CPC H04W 16/10

(57) ABSTRACT

A control device that functions as a RAN Intelligent Controller in an Open-Radio Access Network obtains first information pertaining to a communication amount in each of a plurality of cells provided by the O-RAN; sets a range of frequency resources that can be used preferentially by each of the cells, among frequency resources shared by the plurality of cells; and notifys a processing device of second information indicating at least one of a lower end or an upper end of the range of frequency resources, the range of frequency resources is set such that a range of frequency resources that can be used preferentially by a first cell included in the plurality of cells is at least partially different from a range of frequency resources that can be used preferentially by a second cell included in the plurality of cells.

### CROSS-REFERENCE TO RELATED APPLICATIONS

This application is a continuation of International Patent Application No. PCT/JP2024/035272 filed on October 2, 2024, which claims priority to and the benefit of Japanese Patent Application No. 2023-177740 filed on October 13, 2023 and Japanese Patent Application No. 2024-034151 filed on March 6, 2024, the entire disclosures of which are incorporated herein by reference.

### BACKGROUND OF THE INVENTION

### Field of the Invention

The present invention relates to techniques for controlling radio resources in an Open-Radio Access Network (O-RAN).

### Description of the Related Art

With the spread of wireless communication services, it has become common for users to communicate wirelessly in a variety of environments. For example, at an event venue such as a concert hall or a sports facility such as a stadium, a large number of users communicate in a predetermined area covered by a plurality of cells. In such an environment, providing the wireless communication service efficiently while maintaining communication quality requires optimizing the operations of the wireless communication system while monitoring the communication quality. As such a wireless communication system, functions are being developed for the advanced control of Radio Access Networks (RANs) by collecting information such as the communication quality in cells and analyzing that information. For example, the standardization of Open-RAN (O-RAN), which is aimed at making Radio Access Networks (RANs) more open and intelligent, specifies a RAN Intelligent Controller (RIC) for making the RAN configuration and operation more intelligent (O-RAN Working Group 2, “Non-RT RIC Architecture”, O-RAN Alliance, 2023).

In an environment where a plurality of cells in the same band are located close to each other in a predetermined area, interference that arises among the cells tends to cause a drop in communication quality. Interference is especially likely to occur when frequency resources are shared by cells.

### SUMMARY OF THE INVENTION

The present invention provides a technique for improving RAN communication quality in a communication system using an O-RAN.

A control device according to an aspect of the present invention that functions as a RAN Intelligent Controller (RIC) in an Open-Radio Access Network (O-RAN), the control device comprising: at least one memory that stores a set of instructions; and at least one processor that executes the instructions, the instructions, when executed, causing the control device to perform operations comprising: obtaining first information pertaining to a communication amount in each of a plurality of cells provided by the O-RAN; setting, using the first information, a range of frequency resources that can be used preferentially by each of the cells, among frequency resources shared by the plurality of cells; and notifying a processing device, which executes allocation of radio resources to each of the cells, of second information indicating at least one of a lower end or an upper end of the range of frequency resources, wherein the the range of frequency resources is set such that a range of frequency resources that can be used preferentially by a first cell included in the plurality of cells is at least partially different from a range of frequency resources that can be used preferentially by a second cell included in the plurality of cells and different from the first cell.

A processing device in an Open-Radio Access Network (O-RAN) according to an aspect of the present invention comprising: at least one memory that stores a set of instructions; and at least one processor that executes the instructions, the instructions, when executed, causing the processing device to perform operations comprising: providing first information pertaining to a communication amount in a first cell to a RAN Intelligent Controller (RIC) in the O-RAN, the first cell being included in a plurality of cells provided by the O-RAN and being associated with the processing device; obtaining second information indicating at least one of a lower end or an upper end of a range of frequency resources that can be used preferentially by the first cell among frequency resources shared by the plurality of cells, the second information being generated using the first information; and allocating radio resources to a wireless terminal that connects to the first cell, based on the second information, wherein the range of frequency resources that can be used preferentially by the first cell is set to be at least partially different from a frequency range that can be used preferentially by a second cell included in the plurality of cells and different from the first cell, and when allocating the radio resources to the wireless terminal that connects to the first cell, the allocating performs allocation such that radio resources included in a range of first frequency resources that can be used preferentially by the first cell are allocated preferentially over radio resources included in a range of second frequency resources different from the range of first frequency resources, among the frequency resources shared by the plurality of cells.

Further features of the present invention will become apparent from the following description of exemplary embodiments with reference to the attached drawings.

### BRIEF DESCRIPTION OF THE DRAWINGS

FIG. 1 is a diagram illustrating an example of the configuration of a communication system.

FIG. 2 is a diagram illustrating an example of the hardware configurations of a RIC and a DU.

FIG. 3 is a diagram illustrating an example of the functional configuration of the RIC.

FIG. 4 is a diagram illustrating an example of the functional configuration of the DU.

FIG. 5 is a diagram illustrating an example of the flow of processing executed by the RIC and the DU.

FIG. 6A is a diagram illustrating a relationship between settings for ranges of frequency resources that can be used preferentially by each of the cells and frequency resources actually used in each cell.

FIG. 6B is a diagram illustrating a relationship between settings for ranges of frequency resources that can be used preferentially by each of the cells and frequency resources actually used in each cell.

FIG. 7A is a diagram illustrating an example of the allocation of frequency resources to each of the cells.

FIG. 7B is a diagram illustrating an example of the allocation of frequency resources to each of the cells.

FIG. 8A is a diagram illustrating an example of the allocation of frequency resources to each of the cells.

FIG. 8B is a diagram illustrating an example of the allocation of frequency resources to each of the cells.

FIG. 9 is a diagram illustrating an example of scheduling in each of the cells.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### System Configuration

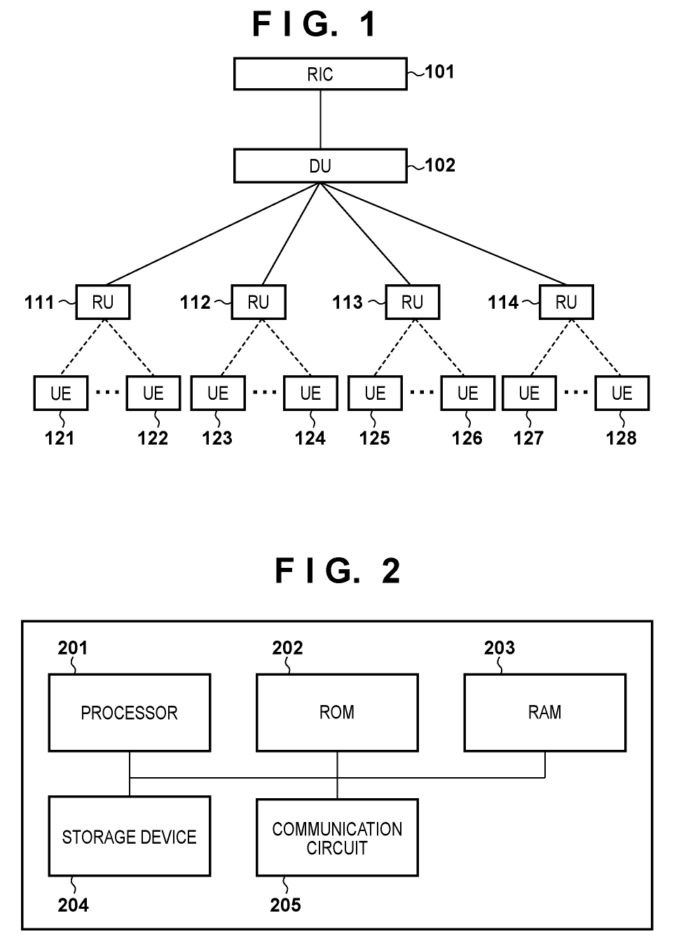

FIG. 1 illustrates an example of the configuration of a communication system according to the present embodiment. This communication system is configured using an Open-Radio Access Network (O-RAN), which is being standardized to make Radio Access Networks (RANs) more open and intelligent. The O-RAN is configured including, for example, a RAN Intelligent Controller (RIC) 101, a Distributed Unit (DU) 102, Radio Units (RUs) 111 to 114, and User Equipment (UE) 121 to 128. In the present embodiment, the RUs 111 to 114 may be collectively referred to as RUs 110. Likewise, in the present embodiment, the UEs 121 to 128 may be collectively referred to as UEs 120. Although FIG. 1 illustrates an example in which one DU 102 is connected to four RUs 111 to 114 over a wired network, two or more DUs 102 may be present, in which case each RU 110 may be connected to a different DU 102. Likewise, the number of RUs 110 connected to the DU 102 may be one, two, or three, or may be five or more. The number of UEs 120 connected to each RU 110 may be zero or more, and a single terminal 100 may be connected to a plurality of base stations 110 at the same time. The devices can be connected to each other over a wired network or a wireless network. Note that in FIG. 1, the solid lines indicate that the devices are connected over a wired network, whereas the dotted lines indicate that the devices are connected over a wireless network. The area in which each RU 110 is capable of communicating over a wireless medium can be called a “cell”.

The RIC 101 designs and sets the parameters of the RAN, automates and optimizes the operation of the RAN, and the like. Note that the RIC 101 can be configured including a Non-Real Time RIC and a Near-Real Time RIC as specified in the O-RAN standard. The Non-Real Time RIC can determine a policy for controlling the long-term behavior of the system as a whole, for example. The Near-Real Time RIC can also control the RAN according to the policy generated by the Non-Real Time RIC, for example. For example, the RIC 101 controls the RAN by providing information necessary for the DU 102 to perform scheduling of cells associated with the DU 102 itself. The DU 102 and the RU 110 cooperate with each other to execute the functions of the RAN. The DU 102 includes functions such as Medium Access Control (MAC), including radio resource allocation in the RAN, Radio Link Control (RLC) such as retransmission control, and the like. For example, the DU 102 has a function for allocating radio resources to a UE 120 connected to a cell associated with the DU 102 itself (scheduling). The RU 110 performs the functions of the wireless physical layer, e.g., for transmitting and receiving radio signals to and from the UE 120 connected to the cell provided by the RU 110 itself. The UE 120 transmits and receives radio signals to and from the RU 110 using the radio resources allocated by the DU 102. The UE 120 includes smartphones, mobile phones, personal computers, tablet terminals, wearable terminals, Internet of Things (IoT) terminals, and the like, for example. Note that the communication system according to the present embodiment can include a central unit (CU) (not shown). The CU can include functions such as Packet Data Convergence Protocol (PDCP), including packet encryption, Radio Resource Control (RRC), and the like.

The RIC 101 can obtain various types of data stored in the DU 102 from the DU 102. Note that the RIC 101 may obtain the various types of data stored in the DU 102 directly from the DU 102, or may obtain the data via another device such as an Element Management System (EMS). For example, the DU 102 can specify a received signal strength (RSSI), an interference amount, and the like in each cell based on a signal received from the RU 110 associated with the DU 102 itself, information obtained from the UE 120 connected to a cell provided by the RU 110, and the like. For example, the RU 110 can calculate the RSSI using a reference signal received from the UE 120. In addition, the DU 102 can identify a communication amount in each cell based on the state of allocation of radio resources to each UE in the scheduling function executed by the DU 102 itself. Note that the information the DU 102 is capable of obtaining is not limited to this information. Meanwhile, the RIC 101 can perform advanced analysis using the data obtained from the DU 102, optimize configuration parameters of the RAN using the results of the analysis, and control the DU 102 using those configuration parameters. For example, the RIC 101 can analyze the information obtained from the DU 102, calculate statistical information such as an average communication amount or interference amount for each cell, generate information necessary for scheduling in each cell using the statistical information, and notify the DU 102. For example, the O-RAN Alliance, which promotes the standardization of O-RAN, specifies an O1 interface, an E2 interface, and the like as communication interfaces for performing communication between the RIC 101 and the DU 102.

The cell provided by each RU 110 is allocated a predetermined frequency band in which that cell can be used for wireless communication. The frequency band can be called a “system band”. The system band may be different from cell to cell, may be the same between cells, or may partially overlap. The system band for each cell may be set in a fixed manner by an operator who manages and operates the communication system, or may be dynamically set by a control device in the communication system, such as the RIC 101. In the present embodiment, it is assumed that the same system band is allocated to each of the cells provided by the RUs 111 to 114. In the scheduling for a cell associated with the DU 102 itself, the DU 102 allocates radio resources in the system band of the cell to which a UE 120 is connected to that UE 120 based on a resource allocation request received from that UE 120, for example. In addition, for example, when data destined for the UE 120 arrives from a network (not shown), the DU 102 allocates radio resources necessary for transmitting the data to the UE 120, for example. The unit of the radio resources allocated to each UE 120 can be called a Physical Resource Block (PRB). For example, the PRB is a frequency and time resource defined by 12 subcarriers on the frequency axis and one subframe (one millisecond) on the time axis. In other words, when executing the scheduling in one radio frame, based on the PRB, the DU 102 can divide the system band into bands of 12 subcarriers each on the frequency axis, divide one radio frame (10 milliseconds) into subframes for each millisecond on the time axis, and allocate the radio resources to each UE 120 in units of PRBs.

As described above, the DU 102 performs the scheduling based on a resource allocation request from the UE 120 or based on the arrival of data from the network at the UE 120. At this time, PRBs at identical locations on the frequency axis and the time axis may be allocated to a plurality of UEs 120 connected to different cells. For example, even when a plurality of RUs 110 are connected to a single DU 102 as illustrated in FIG. 1, the DU 102 can handle the radio resources as if the cells are independent of each other. In this case, for example, when the DU 102 applies the same algorithm to the scheduling of each cell, PRBs at identical locations on the frequency axis and the time axis in the radio frame can be allocated to the plurality of UEs 120 connected to different cells. For example, as the scheduling algorithm, the DU 102 can apply a procedure which takes the PRB at the lowest frequency in the first subframe in the radio frame as the starting location of the radio resource allocation, and performs PRB allocation in the direction towards the highest frequency or the latest time, independently to each of the cells. In this case, it is highly likely that interference between cells will occur in each PRB. In addition, when a plurality of RUs 110 that share the same system band are connected to mutually-different DUs, each DU may not take into consideration the arrangement of the PRBs in the radio frames used in other cells other than the cells associated with that device itself in the scheduling. In this manner, when PRBs at identical locations on the frequency axis and the time axis of the radio frame are used in a plurality of cells, interference can occur among the PRBs if the cells are not spatially separated enough. It is highly likely that a radio signal transmitted in a PRB affected by interference will not be received properly, which may lead to a drop in communication quality, such as a drop in throughput and traffic latency. Especially in an event venue, a sports facility, or the like, a predetermined area is covered by cells provided by a plurality of RUs 110, and such interference is likely to occur in an environment where a large number of UEs 120 communicate wirelessly in that area.

In the present embodiment, in light of such circumstances, the RIC 101 sets a range of frequency resources that can be used preferentially by each cell based on the communication amount of each cell, and notifies the DU 102. The DU 102 allocates a radio resource to a UE 120 connected to a cell associated with that DU 102 itself based on a range of frequency resources that can be used preferentially by each cell, set by the RIC 101. The radio resource is the PRB, for example. When the DU 102 allocates a radio resource to the UE 120 connected to a certain cell, if a PRB that has not yet been allocated is present within the range of frequency resources which that cell can use preferentially, that PRB is allocated preferentially. However, if no PRB that can be allocated is present in the range of frequency resources that the cell can use preferentially, a PRB in the other range of frequency resources in the system band is allocated to the UE 120. It should be noted that the ranges of frequency resources that can be used preferentially by the cells may be different from cell to cell, and may partially overlap. For example, a different frequency can be set for each cell as the lower end of the range of frequency resources that can be used preferentially, and the upper end of the system band can be set to be used universally instead of setting the upper end on a cell-by-cell basis. In this case, the RIC 101 can notify the DU 102 only of the lower end on the frequency axis as the information specifying the range of frequency resources that can be used preferentially by the cell associated with the DU 102. In addition, starting from the lower end of the frequencies, the DU 102 can allocate radio resources of a frequency higher than the lower end of the range of frequency resources set for each cell. Operations performed by each device in the processing for allocating radio resources according to the present embodiment will be described next.

### Obtaining Ratio of Communication Amount among Cells

First, the RIC 101 obtains information enabling the communication amount in each cell to be identified from the DU 102. For example, the information enabling the communication amount of each cell to be identified is an amount of radio resource usage, an amount of data communicated, or the like. As an example, the RIC 101 obtains a PRB utilization rate from the DU 102 as the amount of radio resource usage in each cell. The PRB utilization rate may be, for example, the number of PRBs actually used relative to the total number of PRBs constituting a single radio frame. The PRB utilization rate may be, for example, the number of PRBs allocated by the DU 102 relative to the total number of PRBs constituting a single radio frame. The PRB utilization rate may be individual measured values, or statistical values such as an average value or a maximum value over a certain period of time. Upon executing the scheduling, the DU 102 can calculate the PRB utilization rate per cell based on the number of PRBs allocated to each UE 120. Additionally, the DU 102 may notify the RIC 101 of the number of PRBs allocated to each UE 120, aggregate the number per cell using the number of PRBs of which the RIC 101 has been notified, and calculate the PRB utilization rate for each cell. By obtaining the individual measured values from the DU 102, the RIC 101 can analyze fluctuations in the PRB utilization rate over time and the like in addition to specifying an average value or a maximum value. On the other hand, the RIC 101 can reduce the computational load by obtaining a statistical value or the like calculated by the DU 102. The information for the RIC 101 to specify the communication amount in each cell is not limited to the PRB utilization rate. For example, the RIC 101 can obtain an amount of data communicated in each cell (communication traffic amount) from the DU 102. The communication traffic amount is, for example, the amount of data transmitted by the DU 102 to the UE 120 via the RU 110 and the amount of data received by the DU 102 from the UE 120 via the RU 110. The data amounts may be individual measured values, or statistical values such as an average value or a maximum value over a certain period of time. The information obtained by the RIC 101 from the DU 102 is not limited thereto, and various items of information enabling the communication amount of each cell to be specified can be obtained. The RIC 101 can obtain the PRB utilization rate or the like for each cell from the DU 102 using the O1 interface, the E2 interface, or the like.

The RIC 101 can calculate a ratio of the communication amount among cells based on the obtained amount of radio resource usage, data communicated, or the like of each cell. For example, if the average values of the PRB utilization rates in the cells configured by the RUs 111 to 114 in a certain period are U₁ to U₄, respectively, the RIC 101 can calculate the ratio of the communication amounts of the cells as U₁:U₂:U₃:U₄. Additionally, for example, if the averages of the communication traffic amount in the cells configured by the RUs 111 to 114 in a certain period of time are Tr₁ to Tr₄, the RIC 101 can calculate the ratio of the communication amounts of the cells as Tr₁:Tr₂:Tr₃:Tr₄. Note that the RIC 101 may calculate the ratio of the communication amounts of the cells using the number of PRBs used by each cell, communicated by the DU 102, or the number of PRBs allocated in each cell. The DU 102 can provide the RIC 101 with information specifying fluctuations in the communication amount, such as a maximum value and a minimum value of the PRB utilization rate, a standard deviation, a distribution, and the like for each cell in a predetermined period, an amount of interference received by each cell from another cell, and the like.

Note that when the allocation of radio resources in a specific cell is associated with a predetermined slice, the RIC 101 may obtain information from the DU 102 enabling the communication amount associated with that slice to be specified. For example, there are cases where in a specific cell, the allocation of a set amount of radio resources or the utilization of a set percentage of radio resources out of the overall radio resources is guaranteed for communication associated with the predetermined slice. Note that slicing (network slicing) is a technique that virtually divides a physical network according to the service and responds to various requests for communication quality. For example, the communication traffic over the network can be identified by the DU 102 using an identifier (e.g., Single-Network Slice Selection Assistance Information, or S-NSSAI) assigned to the respective slices. As an example, the information enabling the communication amount associated with a slice in each cell to be specified is an amount of radio resource usage or an amount of data communicated in the communication corresponding to the slice. In addition, the information enabling the communication amount associated with the slice in each cell to be specified may be an amount of radio resources, a percentage of the total radio resources, a communication capacity, or the like to be allocated for that slice, as determined by a predetermined network device including the DU 102, the RIC 101, or the like. The RIC 101 can obtain at least one of the overall communication amount in each cell and the communication amount associated with a slice thereof from each cell as first information pertaining to communication amount. As an example, the RIC 101 can obtain, from the DU 102, the PRB utilization rate in communication in a predetermined slice as the communication amount associated with that predetermined slice from each cell. When performing the scheduling, if the PRB utilization rate is to be communicated based on actual communication results, the DU 102 can calculate the PRB utilization rate associated with each slice on a cell-by-cell basis based on the number of PRBs allocated to the communication associated with the slices, and notify the RIC 101 thereof. Additionally, if the DU 102 guarantees a predetermined PRB utilization rate for a slice, the DU 102 can notify the RIC 101 of the PRB utilization rate. Note that if the PRB utilization rate to be allocated to the slice is determined by a network device other than the DU 102, such as the RIC 101, and provided to the DU 102, the RIC 101 may obtain the PRB utilization rate associated with the slice from that network device. The information that the RIC 101 can obtain from the DU 102 is not limited thereto, and various items of information enabling the communication amount associated with the slices in each cell to be specified can be obtained. The RIC 101 can obtain the PRB utilization rate or the like through communication associated with the slices in each cell from the DU 102 using the O1 interface, the E2 interface, or the like. The communication amount associated with the slice in each cell obtained by the RIC 101 can be used in the setting of the range of frequency resources that can be used preferentially by each cell (described later), in the allocation of radio resources in each cell, and the like to protect the communication associated with the slice from interference from other cells.

### Setting Range of Frequency Resources Each Cell Can Use Preferentially

The RIC 101 sets the range of frequency resources that each cell can use preferentially. In the present embodiment, the frequency resource can be a predetermined frequency band. For example, the RIC 101 can set the range of frequency resources for each cell such that the ranges of frequency resources set for the cells are different from each other. Even if each cell uses the same system band, setting the ranges of frequency resources that the cells use preferentially to be different from each other reduces the likelihood that PRBs at the same location on the frequency axis and the time axis in the radio frame will be used simultaneously in a plurality of cells. Based on the ratio of the communication amounts among the cells, the RIC 101 can set a wide range of frequency resources for a cell having a high ratio of the communication amount, and set a narrow range of frequency resources for a cell having a small ratio of the communication amount. Setting a wide range of frequency resources for a cell having a high communication amount can reduce the likelihood that the PRBs within that range of frequency resources will be insufficient during the scheduling by the DU 102. As an example, if the ratio of the communication amounts in the cells of the RUs 111 to 114 obtained from the DU 102 is U₁:U₂:U₃:U₄, the RIC 101 can divide the system band into four such that the ratio of the resulting bands is U₁:U₂:U₃:U₄, and set each of the four frequency bands as the ranges of frequency resources that can be used preferentially by the cells provided by the RUs 111 to 114.

The RIC 101 may set the ranges of frequency resources such that the ranges of frequency resources that can be used preferentially by the cells are uniform. If the information necessary to specify the communication amount of each cell cannot be obtained from the DU 102, the RIC 101 can set the ranges of frequency resources such that the ranges of frequency resources that can be used preferentially by the cells are uniform. The RIC 101 can also set the ranges of frequency resources such that the ranges of frequency resources that can be used preferentially by the cells are uniform when fluctuations in the communication amount in the cells are large. When the ranges of frequency resources are set using the average value of the communication amount, the number of PRBs that can be allocated in the set range of frequency resources is likely to be insufficient in cells in which the communication amount changes greatly over time. For example, if one or more cells in which parameters indicating fluctuations in the communication amount, such as the standard deviation or the distribution, exceed a predetermined threshold are present, the RIC 101 can set the ranges of frequency resources such that the ranges of frequency resources that can be used preferentially by the cells are uniform. The RIC 101 can also set the ranges of frequency resources such that the ranges of frequency resources that can be used preferentially by the cells are uniform when the communication amount in each cell is lower than a predetermined threshold. In this case, sufficient scheduling is possible using the PRBs in the range of frequency resources set for each cell, and thus the computational load of the RIC 101 for setting the ranges of frequency resources that can be used preferentially by the cells can be reduced.

The RIC 101 can also set the ranges of frequency resources for the cells such that the ranges of frequency resources set for the cells partially overlap. For example, as the lower end of the range of frequency resources that can be used preferentially, the RIC 101 can set frequencies that are different from cell to cell, and set the upper end of the system band as the upper end of that range universally. For example, assume that the frequencies at the lower ends of the ranges of frequency resources set in the respective cells are lowest for the RU 111, followed by the RU 112, the RU 113, and the RU 114, in that order. At this time, for example, in the range of frequency resources set for the RU 111, the number of RUs 110 using the same frequency resources increases as the frequency increases, but the likelihood of interference occurring is lower than when all cells use the same frequency resources. In this case, the RIC 101 can notify the DU 102 only of the lower end of the range of frequency resources set for each cell. Note that as the upper end of the range of frequency resources that can be used preferentially, the RIC 101 may set frequencies that are different from cell to cell, and set the lower end of the system band as the lower end of that range universally.

Note that when a predetermined slice and the allocation of the radio resources are associated in each cell, the RIC 101 may set the ranges of frequency resources that can be used preferentially by the cells in consideration of the communication amount, the allocation of the radio resources, and the like associated with that slice. As described above, setting the ranges of frequency resources that can be used preferentially by the cells to be different from each other reduces the likelihood that radio resources at the same location on the frequency axis and the time axis in the radio frame will be used simultaneously in a plurality of cells. However, when, in one cell among cells for which ranges of frequency resources adjacent to each other on the frequency axis are allocated (a first cell), a communication amount exceeding the range of frequency resources that can be used preferentially by the set first cell occurs in the first cell, the radio resources included in the range of frequency resources that can be used preferentially by the other cell (a second cell) can be used by the first cell. At this time, if radio resources having the same location on the frequency axis and the time axis in the radio frame as the radio resources used by the first cell have been allocated to communication associated with a slice in the second cell, the communication associated with that slice may experience interference from the communication in the first cell. In this case, for example, even if certain radio resources are set to be allocated to the communication associated with that slice in order to achieve the communication quality required for the service associated with that slice, the communication quality may not be achieved due to the interference. Alternatively, it may be necessary to allocate more radio resources to the communication of that slice in order to achieve the communication quality.

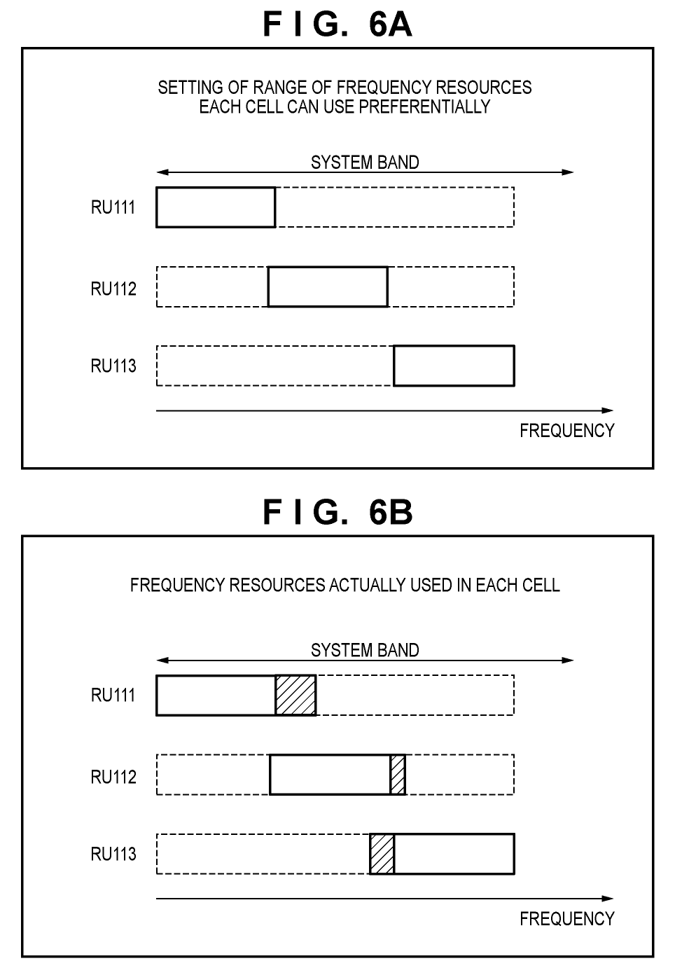

FIGS. 6A and 6B illustrate an example of setting a range of frequency resources that can be used preferentially by each of the cells constituted by each RU, and the frequency resources that include radio resources actually used in each cell, for the RUs 111 to 113, which are three RUs arranged in geographically close locations in the communication system of FIG. 1. FIG. 6A assumes that the ranges of frequency resources that can be used preferentially in the system band are set for the cells configured by the respective RUs, and each of the cells is notified thereof. The horizontal axis is assumed to represent the frequency, and the ranges of frequency resources that can be used preferentially by the cells configured by the RUs 111 to 113 are indicated by the widths of the corresponding rectangles. On the other hand, FIG. 6B illustrates the frequency resources that include the radio resources allocated for the communication that actually occurred in each cell. At this time, as illustrated in FIG. 6B, when the amount of communication that actually occurs exceeds the range of frequency resources that can be used preferentially by each cell, each cell can perform scheduling using radio resources included in ranges of frequency resources adjacent on the frequency axis. For example, each hatched region in FIG. 6B represents a region in which the cell performed scheduling using radio resources in a range of frequency resources adjacent on the frequency axis due to insufficient radio resources in the range of frequency resources that can be used preferentially by the cell itself. In other words, the hatched region indicating the radio resources actually used by the RU 111 is included in the range of frequency resources that the RU 112 can use preferentially. In this region, interference may arise between the RU 111 and the RU 112. At this time, when the radio resources in this region are allocated to the communication associated with a slice, there is the possibility that the communication will fail, and the requested communication quality will not be achieved.

To reduce the effect of such interference that may occur on the communication associated with the slice, the RIC 101 can, for cells in which a predetermined slice and radio resource allocation are associated, set the ranges of frequency resources that can be used preferentially by the cells taking the communication amount associated with that slice into account. For example, the RIC 101 can set the ranges of frequency resources that can be used preferentially by the cells such that the required radio resources are allocated to the corresponding cells based on the information that can specify the communication amount associated with the slice, obtained from each cell. For example, the RIC 101 can modify the ratio of the amount of frequency resources for each cell (an allocation ratio), calculated based on the ratio of the overall communication amount of each cell, based on the communication amount associated with the slice in each cell.

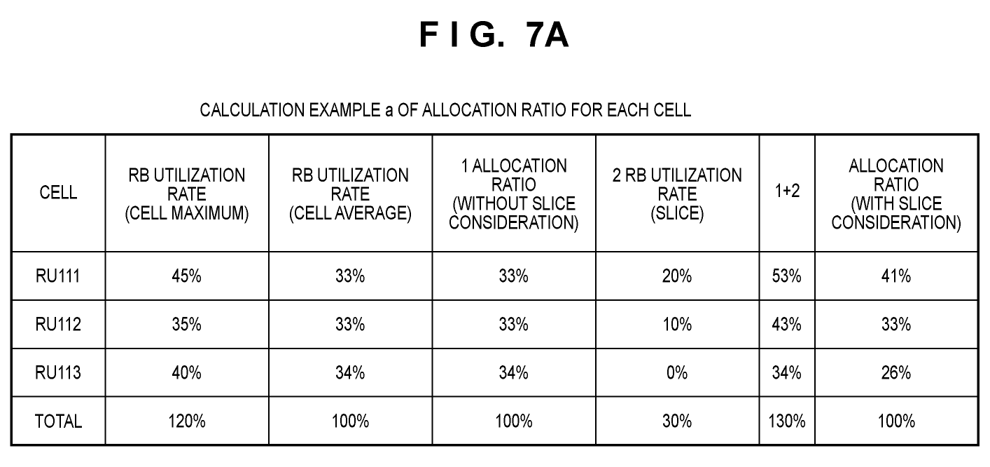

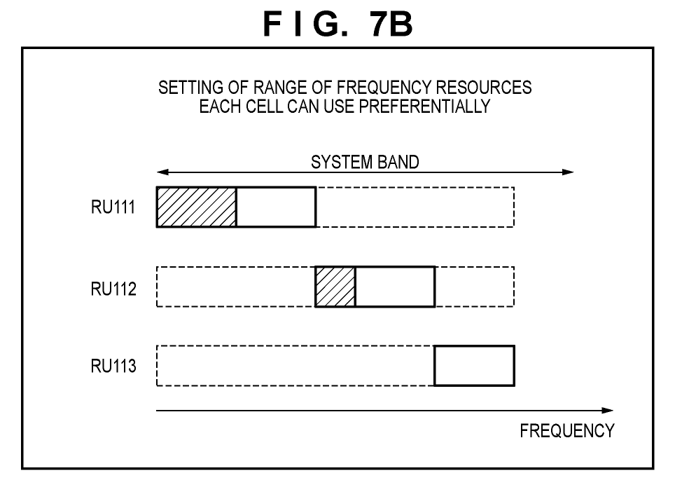

FIG. 7A illustrates calculation example for the allocation ratio for each of the cells configured by the RUs 111 to 113. In this calculation example, the utilization rate of the PRBs (which may be referred to as RBs) is used as the information indicating the communication amount, but other information may be used as the information indicating the communication amount. Assume that the maximum values of the RB utilization rates for the cells of the RUs 111 to 113 are 45%, 35%, and 40%, respectively, and the average RB utilization rates are 33%, 33%, and 34%, respectively. At this time, calculating the allocation ratio for each of the cells of the RUs 111 to 113 based on the average RB utilization rates can result in 33%, 33%, and 34%, respectively. Here, it is assumed that the RB utilization rates corresponding to the communication associated with the slices in the cells of the RUs 111 to 113 are 20%, 10%, and 0%, respectively. Note that the RB utilization rate of each cell can include an RB utilization rate corresponding to the communication associated with the slice. In addition, the RB utilization rate corresponding to the communication associated with the slice may be a maximum value or an average of the RB utilization rate corresponding to the communication associated with the slice in that cell. The RIC 101 modifies the allocation ratio of each cell using a sum (1) + (2) of the calculated allocation ratio (1) of each cell and the RB utilization rate (2) corresponding to the communication associated with the slice of each cell. In other words, an allocation ratio taking the slice into consideration is calculated by calculating (1) + (2) for each cell and normalizing using the total of (1) + (2). For example, the allocation ratios taking into account the slices for the cells of the RUs 111 to 113 can be 41%, 33%, and 26%, respectively.

FIG. 7B illustrates an example of settings for ranges of frequency resources that can be used preferentially by each cell, taking the slice into consideration, that are based on the calculation example in FIG. 7A. The hatched region in FIG. 7B illustrates a percentage corresponding to the communication amount associated with the slice in the range of frequency resources set for each cell. Compared to FIG. 6A, modifying the allocation ratio has resulted in an increase in the set range of frequency resources in accordance with the communication amount associated with the slice in each cell. In this manner, modifying the allocation ratio of each cell such that the added part becomes larger as the communication amount associated with the slice in each cell increases makes it easy to secure frequency resources having little interference for the communication associated with the slice in each cell.

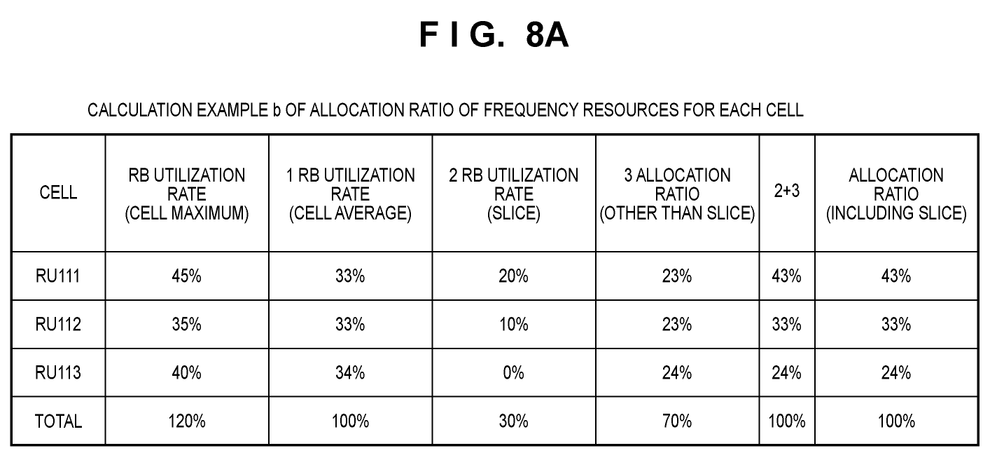

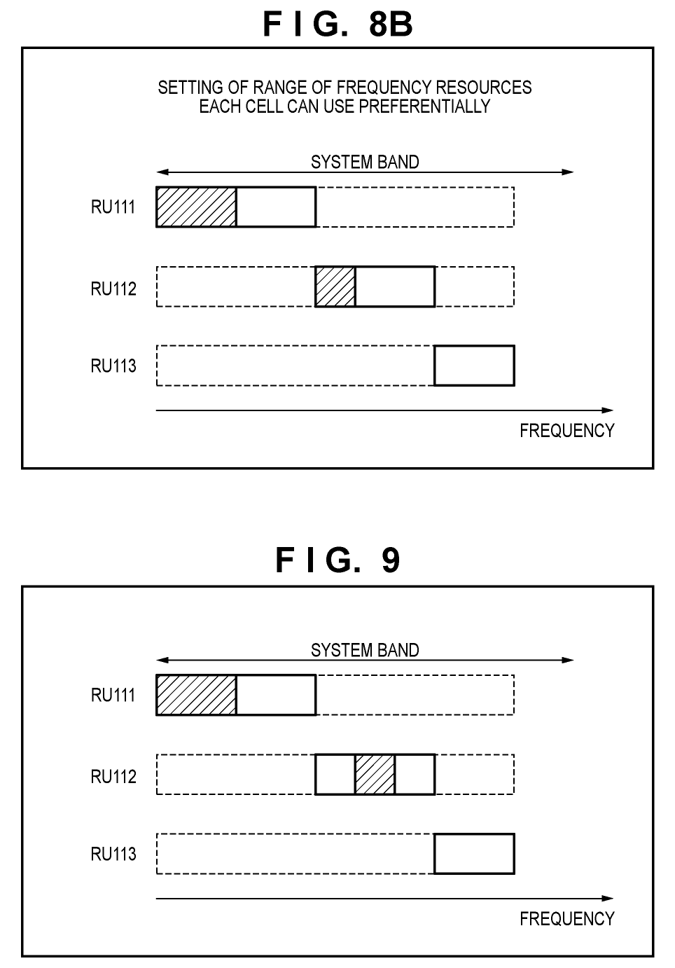

The RIC 101 can also set the ranges of frequency resources that can be used preferentially by the cells such that the radio resources required for the communication amount associated with the slice are secured in advance. FIG. 8A illustrates a different calculation example b for the allocation ratio for each of the cells configured by the RUs 111 to 113. The RB utilization rates for the cells of the RUs 111 to 113 are the same as in FIG. 7A. In this calculation example, the RB utilization rate in the communication associated with the slice of each cell is excluded in advance from the system band, and the remainder is calculated as an allocation ratio (3) based on the average of the RB utilization rates of the cells. In other words, because the RB utilization rates in the communication associated with the slice in the cells of the RU 111 and the RU 112 are 20% and 10%, respectively, 30% is first excluded before calculating the ratio of the amount of frequency resources for each cell (the allocation ratio), which is calculated based on the ratio of the overall communication amount of each cell. The remaining 70% is allocated in accordance with the overall communication amount of each cell as the subject of the allocation ratio. As a result, the allocation ratios (3) of the cells are 23%, 23%, and 24%, respectively. The RIC 101 can then take the sum (2) + (3) of the RB utilization rate according to communication associated with the slice of each cell (2) and the allocation ratio for that other then the slice (3) as the allocation ratio of that cell. For example, the allocation ratios taking into account the slices for the cells of the RUs 111 to 113 can be 43%, 33%, and 24%, respectively.

FIG. 8B illustrates an example of settings for ranges of frequency resources that can be used preferentially by each cell, taking the slice into consideration, that are based on the calculation example in FIG. 8A. The hatched region in FIG. 8B illustrates a percentage corresponding to the communication amount associated with the slice in the range of frequency resources set for each cell. Compared to FIG. 6A, the set range of frequency resources has increased in accordance with the communication amount associated with the slice in each cell, in the same manner as in FIG. 7B. In this manner, calculating the allocation ratio such that the communication amount associated with the slice of each cell is excluded from the system band for being secured in advance makes it possible to reliably secure frequency resources having little interference for the communication associated with the slice.

The RIC 101 arranges the frequency resources set for each cell on the frequency axis. For example, the RIC 101 may arrange the ranges of frequency resources set for each cell on the frequency axis based on information specific to that cell. As an example, the RIC 101 can arrange the frequency resources to be set in the cells such that the frequency on the frequency axis decreases or increases as the numerical value in an identifier becomes smaller or greater in the cell. The identifier of the cell is, for example, a Physical Layer Cell Identifier (PCI). Using the information specific to the cells makes it possible for the RIC 101 to arrange the ranges of frequency resources set for the cells on the frequency axis without obtaining additional information from the DU 102. The RIC 101 can also arrange the ranges of frequency resources set for the cells on the frequency axis such that the frequency decreases or increases as the range of frequency resources set in the cell broadens. Generally, a cell having a high communication amount ratio is likely to experience greater fluctuations in communication amount over time compared to a cell having a low communication amount ratio. For example, assume that, when performing scheduling for each cell, the DU 102 starts allocating the radio resources from the lower end of the range of frequency resources set for the cell and allocates lower-frequency radio resources preferentially. At this time, collecting cells having a broad set range of frequency resources to the lower frequencies makes it possible to reduce the number of cells subject to interference when radio resources in the range of frequency resources set for that cell are insufficient and radio resources in the range of frequency resources set for a cell adjacent on the frequency axis are allocated. On the other hand, if the cells are arranged at the lower frequencies in the system band for cells having narrower set ranges of frequency resources, there is no chance that the cells will experience interference from other cells arranged at the higher frequencies. The RIC 101 may also arrange the range of frequency resources set for each cell on the frequency axis based on fluctuations in the communication amount of each cell. For example, by performing the arrangement such that the frequency is lower for cells having smaller fluctuations in the communication amount, the RIC 101 can reduce the likelihood that the cells having smaller fluctuations in the communication amount will experience interference when the PRBs of the cells having larger fluctuations in the communication amount are insufficient. The RIC 101 may also arrange the range of frequency resources set for each cell on the frequency axis based on the magnitude of interference between cells. For example, the RIC 101 can obtain information for specifying an interference amount between cells from the DU 102. As one example, the information for specifying the interference amount between cells may be an interference amount measured for a certain cell (a cell to be measured) in a predetermined period and the PRB utilization rate of each other cell in that period. The interference amount is, for example, the RSSI of an interference signal, the length of time for which an interference signal was received, or a combination thereof. The RIC 101 can identify a cell having a high PRB utilization rate as a cell that produces interference with the cell to be measured during periods when the interference amount in the cell to be measured is large. The interference amount being large refers to, for example, when the RSSI of the interference signal is greater than a predetermined threshold, or when the period in which the interference signal is detected is longer than a predetermined threshold. The cell having a high PRB utilization rate may be a cell having a PRB utilization rate higher than a predetermined threshold, or may be the cell having the highest PRB utilization rate among the plurality of cells. The RIC 101 can specify cells in a relationship that produces interference with each other, and arrange the range of frequency resources set for each cell on the frequency axis such that those cells are not adjacent. Ensuring the ranges of frequency resources are not adjacent on the frequency axis makes it possible to reduce the probability that PRBs at the same location on the frequency axis and the time axis in the radio frame will be used simultaneously by a plurality of cells in a relationship that produces interference with each other, when the PRBs in one cell are insufficient. The RIC 101 may also specify cells that are not in a relationship that produces interference with each other, and arrange the range of frequency resources set for each cell on the frequency axis such that those cells are adjacent. Note that the method by which the RIC 101 arranges the range of frequency resources set for each cell on the frequency axis is not limited to the foregoing.

The RIC 101 may arrange the range of frequency resources set for the cells on the frequency axis based on the presence or absence of an association between a predetermined slice and radio resource allocation in each cell. For example, the RIC 101 may arrange the ranges of frequency resources set for the cells on the frequency axis such that the range of frequency resources set for a cell in which the slice and the radio resource allocation are associated is not adjacent, on the frequency axis, to a range of frequency resources set for a cell that can interfere with the stated cell. The cell that can interfere with the cell in which the slice and the radio resource allocation are associated can be, for example, a cell spatially adjacent to that cell, a cell having a high frequency resource utilization rate, a cell in which the frequency resource utilization rate fluctuates greatly on the time axis, or the like. Arranging the cell in which the slice and the radio resource allocation are associated and the cell that can produce interference at positions distanced from each other on the frequency axis makes it possible to reduce the likelihood of interference with the cell in which the slice and the radio resource allocation are associated.

The RIC 101 notifies the DU 102 of the range of frequency resources that each cell can use preferentially. The RIC 101 can notify the DU 102 of the lower end of the range of frequency resources, the upper end, or both. The RIC 101 can notify the DU 102 of a frequency fₛₜₐᵣₜ, indicating the lower end of the range of frequency resources, and a frequency f_{end}, indicating the upper end, for example. The RIC 101 can also make a notification of the range of frequency resources using indexes of the PRBs. For example, in the range of frequency resources, if the index of the PRB corresponding to the lowest frequency is represented by Nₛₜₐᵣₜ and the index of the PRB corresponding to the highest frequency is represented by N_{end}, the lower end of the range of frequency resources can be expressed as Nₛₜₐᵣₜ, and the upper end as N_{end}. Here, N represents an index of the PRB on the frequency axis. Note that the RIC 101 may notify the DU 102 of a combination of the lower end or the upper end of the range of frequency resources and a bandwidth. For example, the RIC 101 can notify the DU 102 of a combination of the frequency fₛₜₐᵣₜ indicating the lower end of the range of frequency resources, or the frequency f_{end} indicating the upper end of the range of frequency resources, and f_{width}, which represents the bandwidth. The RIC 101 can also notify the DU 102 of a combination of the PRB index Nₛₜₐᵣₜ indicating the lower end of the range of frequency resources, or the PRB index N_{end} indicating the upper end of the range of frequency resources, and N_{width}, which represents the number of PRBs. The RIC 101 can notify the DU 102 of the range of frequency resources through another method. For example, the RIC 101 can notify the DU 102 of a combination of a center frequency f_{c} of the frequency resource and the bandwidth. The RIC 101 can also make a notification of the lower end and the upper end of the frequency resources using a relative value (offset) based on the lower end or upper end of the system band. The RIC 101 can notify the DU 102 of the resources of the frequency of each set cell using the O1 interface or the E2 interface. For example, the RIC 101 can notify the DU 102 of a combination of an identifier that specifies the cell (e.g., a PCI) and the lower end, upper end, or both of the range of frequency resources set for the cell or information that specifies the range of frequency resources.

The RIC 101 can change the range of frequency resources that each cell can use preferentially. For example, the RIC 101 can periodically obtain information that can specify the communication amount, interference amount, or the like in each cell from the DU 102, and change the range of frequency resources that can be used preferentially by the cell based on this information. Setting an appropriate range of frequency resources for each cell in accordance with changes in the communication environment in each cell can reduce the likelihood of interference occurring between cells. The RIC 101 can also change the range of frequency resources that can be used preferentially by each cell according to the purpose of the facility in which the cells are located. For example, large-scale facilities such as stadiums may be used for various purposes, such as baseball, soccer, track and field competitions, concerts, and various other types of events. The RIC 101 can change the range of frequency resources that can be used preferentially by each cells in each of predetermined patterns based on the purpose, the arrangement of the seats, and the like. The RIC 101 includes a correspondence table of ranges of frequency resources that can be used preferentially by the cells according to the predetermined patterns, and the range of frequency resources that can be used preferentially by each cell can be changed based on inputs from an operator that manages and operates the communication system.

### Allocation of Radio Resources to Each UE

The DU 102 performs scheduling for the UE 120 connected to the cell associated with the DU 102 itself based on the range of frequency resources that can be used preferentially by each cell, as communicated by the RIC 101. The DU 102 preferentially allocates radio resources included in the range of frequency resources set for each cell to the UE 120 connected to that cell. If no radio resources that can be allocated are present in the range of frequency resources set for each cell, the DU 102 can perform the allocation using radio resources in another range of frequency resources included in the system band. As an example, the DU 102 first obtains a range of frequency resources that can be used preferentially by each cell from the RIC 101. For example, assume that the DU 102 has obtained N_{start,1} = 0, N_{start,2} = 3, N_{start,3} = 8, and N_{start,4} = 10 as the information specifying the ranges of frequency resources that can be used preferentially by the cells corresponding to the RU 111, the RU 112, the RU 113, and the RU 114, respectively. Here, it is assumed that the system band is constituted by PRBs for which N = 0 to 11. In this case, the DU 102 can interpret that ranges of frequency resources of N = 0 to 2, 3 to 7, 8 to 9, and 10 to 11 have been set for the cells corresponding to the RUs 111 to 114, respectively. That is, the DU 102 can interpret that, in two cells adjacent to each other on the frequency axis, the lower end of the range of frequency resources of the cell for which a range of frequency resources of a higher frequency is set is the upper end of the range of frequency resources of the other cell. The DU 102 may also interpret that for the same information as above, frequency ranges of N = 0 to 11, 3 to 11, 8 to 11, and 10 to 11 have been set for the cells corresponding to the RUs 111 to 114, respectively. In this case, the DU 102 interprets that the upper end of the range of frequency resources set for each cell is the upper end of the system band.

The DU 102 then performs the scheduling of radio frames based on the resource allocation request from the UE 120, the arrival of data from the network to the UE 120, and the like. For example, if a resource allocation request is made from the UE 121 connected to the RU 111, the DU 102 allocates a PRB having a PRB index of N = 0, which is the lower end (starting location) of the range of frequency resources set for the cell corresponding to the RU 111, to the UE 121. If a resource allocation request is similarly made from the UE 122, the DU 102 allocates a PRB having a PRB index of N = 1 to the UE 122. If a resource allocation request is made from the UE 123 connected to the RU 112, the DU 102 allocates a PRB having a PRB index of N = 3, which is the starting location of the range of frequency resources set for the cell corresponding to the RU 112, to the UE 123. In this manner, in scheduling for cells that are different from each other, the starting locations of the radio resources to be allocated are set to be different, which reduces the likelihood that PRBs at identical locations on the frequency axis and the time axis in the radio frame will be used simultaneously by a plurality of cells. On the other hand, if a resource allocation request is made from the UE 124 connected to the RU 112, and PRBs having PRB indices from N = 3 to 7 are already allocated to other UEs 120 connected to the same cell, the DU 102 can allocate a PRB having a PRB index of N = 8 to the UE 124. Note that at this time, it is possible that the DU 102 has allocated a PRB of N = 8 to the UE 125 based on a resource allocation request made from the UE 125 connected to the RU 113. In this case, the same PRB of N = 8 is used simultaneously by the UE 124 and the UE 125, and thus interference may arise therebetween. However, in the scheduling for each cell, the PRBs used preferentially by the cells are different from each other, which significantly reduces the possibility of such interference. In addition, when the RIC 101 arranges the range of frequency resources set for each cell on the frequency axis, if a plurality of cells in a relationship that produces interference with each other are arranged such that the cells are not adjacent on the frequency axis, such interference will not occur. Although the present embodiment describes a case where one PRB is allocated to each UE 120 as an example, two or more PRBs may be allocated to each UE 120.

The DU 102 may allocate radio resources toward lower frequencies from the upper end of the range of frequency resources. For example, in the foregoing example, the DU 102 can interpret that frequency ranges of 2, 7, 9, and 11 have been set as the upper ends of the ranges of frequency resources set for the cells corresponding to the RUs 111 to 114, respectively. At this time, if a resource allocation request is made from the UE 121 connected to the RU 111, the DU 102 allocates a PRB having a PRB index of N = 2, which is the upper end (starting location) of the range of frequency resources set for the cell corresponding to the RU 111, to the UE 121. If a resource allocation request is similarly made from the UE 122, the DU 102 allocates a PRB having a PRB index of N = 1 to the UE 122. If a resource allocation request is made from the UE 123 connected to the RU 112, the DU 102 allocates a PRB having a PRB index of N = 7, which is the starting location of the range of frequency resources set for the cell corresponding to the RU 112, to the UE 123. Note that the scheduling method executed by the DU 102 is not limited thereto. For example, a scheduling method for allocating radio resources toward higher frequencies from the lower end of the range of frequency resources, and a scheduling method for allocating radio resources toward lower frequencies from the upper end of the range of frequency resources, may be changed from cell to cell and applied. For example, if a resource allocation request is made from the UE 121 connected to the RU 111, the DU 102 allocates a PRB having a PRB index of N = 0, which is the lower end (starting location) of the range of frequency resources set for the cell corresponding to the RU 111, to the UE 121. If a resource allocation request is similarly made from the UE 122, the DU 102 allocates a PRB having a PRB index of N = 1 to the UE 122. If a resource allocation request is made from the UE 123 connected to the RU 112, the DU 102 allocates a PRB having a PRB index of N = 7, which is the upper end (starting location) of the range of frequency resources set for the cell corresponding to the RU 112, to the UE 123. In this manner, widening the distances of the radio resources serving as the starting location for scheduling between cells adjacent to each other on the frequency axis makes it possible to reduce the likelihood that an increase in the communication amount in one of the cells will produce interference with another cell.

Note that when a predetermined slice and radio resource allocation are associated with each other in a specific first cell, the DU 102 may preferentially allocate radio resources having a low likelihood of producing interference to the communication associated with that slice. As described above, in the scheduling in a cell in the DU 102, when radio resources near the lower end or upper end of the range of frequency resources that can be used preferentially by the first cell are allocated, the likelihood that communication using those radio resources will be affected by interference from other cells is relatively high. However, when radio resources far from the lower end or upper end of the range of frequency resources that can be used preferentially by the first cell are allocated, the likelihood that communication using those radio resources will be affected by interference from other cells is relatively low. Accordingly, the DU 102 can allocate radio resources that are far from the lower end or upper end of the range of frequency resources that can be used preferentially by the first cell to the communication associated with the slice. In other words, when the range of frequency resources that can be used preferentially by the first cell is taken as a range of first frequency resources and a different range of frequency resources included in the system band is taken as a range of second frequency resources, in the frequency region, the DU 102 allocates radio resources in the range of first frequency resources, among the first frequency resources, not included in a predetermined frequency range from a boundary between the range of first frequency resources and the range of second frequency resources, to communication corresponding to a predetermined network slice, with preference over radio resources in the range of first frequency resources, among the range of first frequency resources, included in the predetermined frequency range. As an example, first, in addition to information that specifies the range of frequency resources that can be used preferentially by the first cell from the RIC 101, the DU 102 obtains information enabling estimation of a range of frequency resources that can be used preferentially by an other second cell that can use a range of frequency resources adjacent to the stated range preferentially (a cell adjacent on the frequency axis), and an amount of the frequency resources the second cell can use. The information that enables estimation of the amount of frequency resources that can be used by the second cell can be, for example, a utilization amount or utilization rate of the frequency resources used by the second cell in a past predetermined period, the maximum value of the data amount (communication traffic amount), or the like. The information that enables estimation of the amount of frequency resources that can be used by the second cell can be the utilization amount or utilization rate, per unit of time, of the frequency resources used by the second cell in a past predetermined period, or the average value and distribution of the data amount (communication traffic amount), but is not limited thereto, and the information may be any statistical amount enabling the estimation of the amount of frequency resources required to communicate the communication traffic arising in the second cell. For example, the DU 102 can use the maximum value per unit of time of the frequency resources used by the second cell in a past predetermined period as the amount of frequency resources that can be used by the second cell. Based on the range of frequency resources that can be used preferentially by the second cell and the amount of frequency resources that can be used by the second cell, the DU 102 specifies a range of frequency resources susceptible to interference in the range of frequency resources that can be used preferentially by the first cell. For example, the DU 102 can calculate a difference between the amount of frequency resources that can be used by the second cell and the amount of frequency resources included in the range of frequency resources that can be used preferentially by the second cell, and specify, as a range of frequency resources susceptible to interference, a range corresponding to that difference from the boundary between the range of frequency resources that can be used preferentially by the first cell and the range of frequency resources that can be used preferentially by the second cell. Then, the DU 102 performs scheduling so as to preferentially allocate radio resources included in the range of frequency resources that can be used preferentially by the first cell, aside from the range of frequency resources susceptible to interference, to the communication associated with the slice. In this manner, the DU 102 can protect the communication associated with the slice from interference by preferentially allocating, to the communication associated with the slice, a range other than the range susceptible to interference from adjacent cells on the frequency axis in the range of frequency resources that can be used preferentially by the first cell (that is, a range not susceptible to interference).

The method by which the DU 102 preferentially allocates radio resources having a low likelihood of producing interference to the communication associated with the predetermined slice is not limited to the foregoing. For example, the DU 102 may perform the scheduling assuming that, in the range of frequency resources that can be used preferentially by the first cell, locations closer to the center of that range are less likely to produce interference. As described above, locations closer to the lower end or upper end of a range are more likely to be affected by interference from cells adjacent on the frequency axis, and thus allocating the frequency resources preferentially from the center of the range to the communication associated with the slice makes it possible to protect the communication associated with the slice from interference. Note that when a range of frequency resources that is lower than, or higher than, the range of frequency resources that can be used preferentially by the DU 102 itself is not allocated to another cell (i.e., when the range of frequency resources that can be used preferentially by the DU 102 itself is a range of frequency resources at the upper end or lower end of the system band), the DU 102 can preferentially allocate radio resources starting from the radio resources included in the frequency resources at the lower end or upper end to the communication associated with the slice. Because no adjacent cells are present on the frequency axis, a situation where the communication associated with the slice is affected by interference can be avoided. In addition, the DU 102 may perform scheduling such that frequency resources that are in a predetermined range from the lower end or upper end of the range of frequency resources that can be used preferentially by the first cell are taken as frequency resources susceptible to interference, and frequency resources included in a different range are preferentially allocated to the communication associated with the slice. For example, by avoiding the allocation of frequency resources that are in a predetermined range from the lower end or upper end of the range of frequency resources that can be used preferentially by the first cell, it is possible to avoid a situation where the communication associated with the slice is affected by interference.

FIG. 9 illustrates an example of scheduling radio resources in the cells configured by the RUs 111 to 113. The horizontal axis represents the frequency, and the ranges of frequency resources that can be used preferentially by each cell are indicated by the widths of the corresponding rectangles. The frequency resources including the radio resources allocated to the communication associated with the slice in each cell are indicated by hatching. Since the RU 111 is allocated a range of frequency resources at the lower end of the system band, frequency resources can be allocated to the communication associated with the slice preferentially from the lower end of the range. However, in the RU 112, radio resources can be allocated preferentially to the communication associated with the slice starting with radio resources at the center of the frequency resources that can be used preferentially (or radio resources a predetermined range away from the upper end or lower end of the frequency resources that can be used preferentially). For communications other than the communication associated with the slice in each cell, the frequency resources can be allocated in a range excluding the hatched range, e.g., in order from the lower end of that range.

### Device Configuration

An example of the configuration of the above-described RIC 101 and DU 102 will be described next. FIG. 2 is a diagram illustrating the hardware configurations of the RIC 101 and the DU 102. In one example, the RIC 101 and the DU 102 include a processor 201, a ROM 202, a RAM 203, a storage device 204, and a communication circuit 205. The processor 201 is a computer configured including at least one processing circuit, such as a general-purpose Central Processing Unit (CPU), an Application-Specific Integrated Circuit (ASIC), or the like. The processor 201 executes overall processing of the device, each of the aforementioned processes, and the like by reading out programs stored in the ROM 202, the storage device 204, and the like and executing those programs. The ROM 202 is a read-only memory in which programs, information such as various parameters, and the like pertaining to the processing executed by the RIC 101 and the DU 102 are recorded. The RAM 203 functions as a workspace when the processor 201 executes programs, and is a random access memory in which temporary information is recorded. The storage device 204 is constituted by, for example, a removable external storage device or the like. The communication circuit 205 is configured including a circuit for communicating with other devices, for example. As an example, the communication circuit 205 can function as an O1 interface, an E2 interface, or the like. Although one communication circuit 205 is illustrated in FIG. 2, each device can have a plurality of communication circuits.

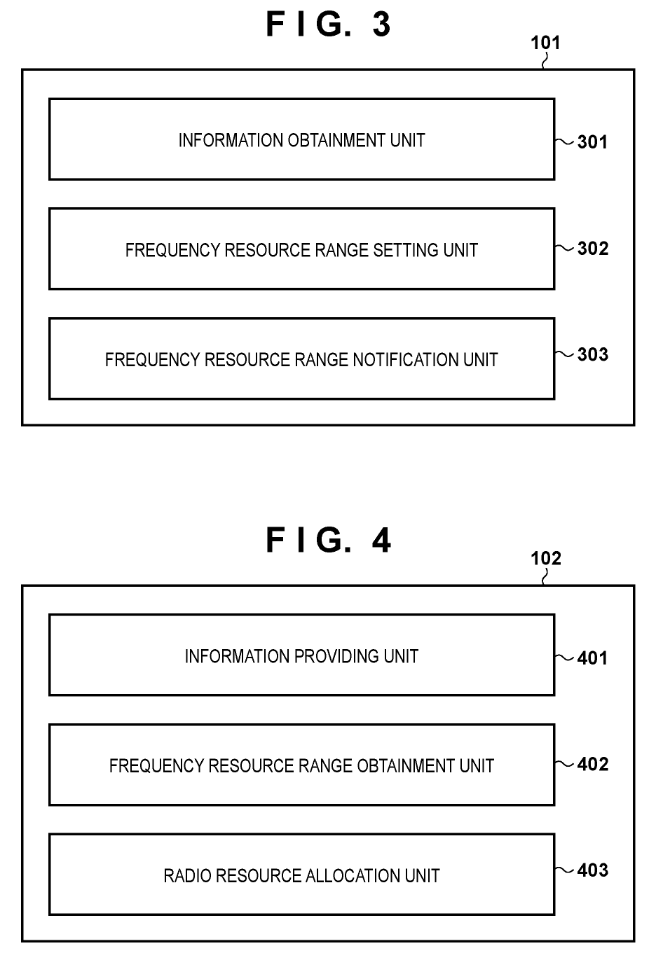

FIG. 3 is a diagram illustrating an example of the functional configuration of the RIC 101. The RIC 101 is configured including an information obtainment unit 301, a frequency resource range setting unit 302, and a frequency resource range notification unit 303, for example, as functions thereof. FIG. 3 illustrates the functional configuration of the RIC 101 according to the present embodiment, and omits the general configuration of a RIC, for example. Note that these function units can be implemented, for example, by the processor 201 executing programs stored in the ROM 202, the storage device 204, or the like, and controlling the communication circuit 205 as necessary. However, the configuration is not limited thereto, and for example, dedicated hardware for implementing each function may be provided.

The information obtainment unit 301 obtains the information enabling the communication amount in each cell to be specified. For example, the information obtainment unit 301 can obtain a radio resource utilization amount, a traffic amount, or the like in each cell as information enabling the communication amount in each cell to be specified. The radio resource is the PRB, for example. The information obtainment unit 301 can obtain the information enabling the communication amount in each cell to be specified by communicating with the DU 102 using the O1 interface or the E2 interface implemented by the communication circuit 205. The frequency resource range setting unit 302 determines the range of frequency resources that can be used preferentially by each cell. For example, the frequency resource range setting unit 302 specifies the ratio of the communication amount for each cell, and can set a larger range of frequency resources for the cell as the ratio of the communication amount increases. The frequency resource range setting unit 302 can also set the range of the frequency resources of each cell such that the ranges of frequency resources set for the cells are different from each other. Note that a part of the range of frequency resources set for each cell may overlap with a part of the range of frequency resources set for another cell. The frequency resource range setting unit 302 can also arrange the range of frequency resources set for each cell on the frequency axis, and adjust the order thereof. For example, using the interference amount in the cells, the frequency resource range setting unit 302 can arrange the range of frequency resources set for each cell such that a plurality of cells that can interfere with each other are not adjacent on the frequency axis. The frequency resource range notification unit 303 notifies the DU 102 of the range of frequency resources that can be used preferentially by each cell, arranged on the frequency axis. The frequency resource range notification unit 303 can notify the DU 102 of the lower end or the upper end of the range of frequency resources, or both. The frequency resource range notification unit 303 may also notify the DU 102 of information specifying the range of frequency resources. Note that the frequency resource range notification unit 303 can use the O1 interface or E2 interface implemented by the communication circuit 205 to make a notification of a combination of an identifier that identifies the cell (e.g., the PCI) and the lower end, upper end, or both of the range of frequency resources that can be used preferentially by the cell or the information specifying the range of frequency resources that can be used preferentially by the cell.

When a predetermined slice and radio resource allocation are associated in a cell in which the DU 102 controlled by the RIC 101 performs scheduling, the information obtainment unit 301 can obtain the utilization amount of frequency resources, the traffic amount, and the like in the communication associated with the slice in the cell as the information pertaining to the communication amount in that cell. In addition, when determining the range of frequency resources that can be used preferentially by each cell, the frequency resource range setting unit 302 can set the range of frequency resources to be larger for cells having greater communication amounts associated with the predetermined slice, such that the frequency resources required for communication associated with the predetermined slice in each cell can be secured more easily.

FIG. 4 is a diagram illustrating an example of the functional configuration of the DU 102. The DU 102 is configured including an information providing unit 401, a frequency resource range obtainment unit 402, and a radio resource allocation unit 403, for example, as functions thereof. FIG. 4 illustrates the functional configuration of the DU 102 according to the present embodiment, and omits the general configuration of a DU, for example. Note that these function units can be implemented, for example, by the processor 201 executing programs stored in the ROM 202, the storage device 204, or the like, and controlling the communication circuit 205 as necessary. However, the configuration is not limited thereto, and for example, dedicated hardware for implementing each function may be provided. The information providing unit 401 provides the information enabling the communication amount in each cell to be specified to the RIC 101. The information providing unit 401 can provide the information enabling the communication amount in each cell to be specified by communicating with the RIC 101 using the O1 interface or the E2 interface implemented by the communication circuit 205. The frequency resource range obtainment unit 402 obtains the range of frequency resources that can be used preferentially by the cells associated with the DU 102 itself from the RIC 101. For example, the frequency resource range obtainment unit 402 can use the O1 interface or E2 interface implemented by the communication circuit 205 to obtain a combination of an identifier that identifies the cell (e.g., the PCI) and the lower end, upper end, or both of the range of frequency resources that can be used preferentially by the cell or the information specifying the range of frequency resources that can be used preferentially by the cell. The radio resource allocation unit 403 allocates radio resources to the UE 120 based on the range of frequency resources set for each cell. The radio resource allocation unit 403 preferentially allocates, to the UE 120, radio resources (PRBs) included in the range of frequency resources that can be used preferentially by the cell to which the UE 120 connects. If the lower end of the range of frequency resources set for the cell associated with the DU 102 itself is obtained, the radio resource allocation unit 403 can allocate radio resources higher than this lower end from a lower frequency. Likewise, if the upper end of the range of frequency resources set for the cell associated with the DU 102 itself is obtained, the radio resource allocation unit 403 can allocate radio resources lower than this upper end from a higher frequency.

When a predetermined slice and radio resource allocation are associated in a cell for which the DU 102 performs scheduling, the information providing unit 401 can provide the utilization amount of frequency resources, the traffic amount, and the like in the communication associated with the predetermined slice in the cell to the RIC 101 as the information pertaining to the communication amount in that cell. In addition, the radio resource allocation unit 403 can perform the allocation to the communication associated with the slice with preference to a range that is less susceptible to interference from adjacent cells on the frequency axis, in the range of frequency resources that can be used preferentially by each cell.

### Flow of Processing

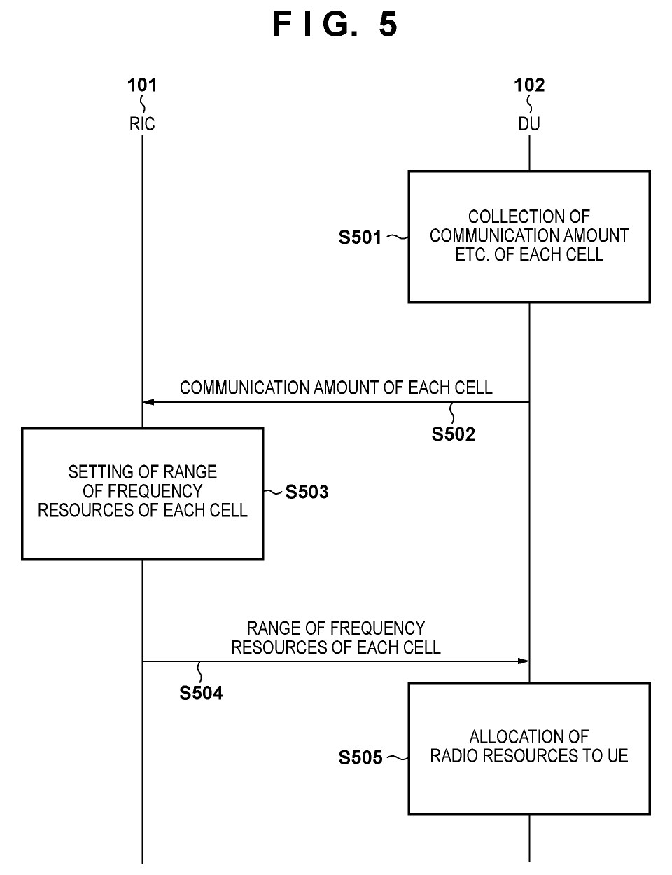

FIG. 5 illustrates an example of the flow of processing executed by the RIC 101 and the DU 102 according to the present embodiment. First, the DU 102 collects the communication amount and the like in each cell (S501). For example, the DU 102 can obtain a radio resource utilization amount in each cell based on information about the scheduling performed by the DU 102 itself. In addition, the DU 102 can obtain the traffic amount of each cell based on the amount of data transmitted from the UE 120 to the network via the DU 102 itself and the amount of data transmitted from the network to the UE 120 via the DU 102 itself. The DU 102 then notifies the RIC 101 of information specifying the communication amount in each cell (S502). The RIC 101 specifies the ratio of the communication amount for each cell and sets the range of frequency resources that can be used preferentially by each cell based on the ratio. Here, the ranges of frequency resources set for the cells are set to be at least partially different. The RIC 101 can also arrange each of the ranges of frequency resources that can be used preferentially by each cell on the frequency axis. For example, the RIC 101 can arrange the ranges of frequency resources that can be used preferentially by the cells such that a plurality of cells that can interfere with each other are not adjacent on the frequency axis. The RIC 101 notifies the DU 102 of the range of frequency resources in each cell (S504). Based on the range of frequency resources set for the cell provided by the RU 110 associated with the DU 102 itself, the DU 102 allocates radio resources to the UE 120 connected to that cell (S505). For example, if the lower limit of the range of frequency resources that can be used preferentially by the cell is obtained, the DU 102 allocates radio resources having a frequency higher than the lower end, starting from a lower frequency. Likewise, for example, if the upper end of the range of frequency resources that can be used preferentially by the cell is obtained, the DU 102 allocates radio resources having a frequency lower than the upper end, starting from a higher frequency.

As described above, according to the present embodiment, in a RAN in which a plurality of cells share frequency resources, a range of frequency resources that can be used preferentially by each cell is set, and in scheduling for a UE connected to each cell, radio resources included in the range of frequency resources set in the cell connected to the UE are allocated preferentially. Through this, the likelihood of mutual interference occurring when PRBs at the same location on the frequency axis and the time axis of the radio frame are used simultaneously in a plurality of cells can be reduced. On the other hand, if radio resources are insufficient in the ranges of frequency resources set in some cells, interference is allowed to occur, and radio resources outside the range of frequency resources that can be used preferentially by those cells are allocated. Through this, the radio resources required for scheduling can be allocated flexibly even when a predetermined range of frequency resources is set for a cell having a large fluctuation in the communication amount. In this manner, according to the present embodiment, the communication quality, such as RAN throughput, traffic latency, and the like can be improved. This makes it possible to contribute to Goal 9 of the United Nations-led Sustainable Development Goals (SDGs), which is to “build resilient infrastructure, promote inclusive and sustainable industrialization, and foster innovation”.

The invention is not limited to the foregoing embodiments, and various variations/changes are possible within the spirit of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A control device that functions as a RAN Intelligent Controller (RIC) in an Open-Radio Access Network (O-RAN), the control device comprising: at least one memory that stores a set of instructions; and at least one processor that executes the instructions, the instructions, when executed, causing the control device to perform operations comprising: obtaining first information pertaining to a communication amount in each of a plurality of cells provided by the O-RAN ;setting, using the first information, a range of frequency resources that can be used preferentially by each of the cells, among frequency resources shared by the plurality of cells; and notifying a processing device, which executes allocation of radio resources to each of the cells, of second information indicating at least one of a lower end or an upper end of the range of frequency resources, wherein the the range of frequency resources is set such that a range of frequency resources that can be used preferentially by a first cell included in the plurality of cells is at least partially different from a range of frequency resources that can be used preferentially by a second cell included in the plurality of cells and different from the first cell.

2. A control device that functions as a RAN Intelligent Controller (RIC) in an Open-Radio Access Network (O-RAN), the control device comprising: at least one memory that stores a set of instructions; and at least one processor that executes the instructions, the instructions, when executed, causing the control device to perform operations comprising: obtaining first information pertaining to a communication amount in each of a plurality of cells provided by the O-RAN;
setting, using the first information, a range of frequency resources that can be used preferentially by each of the cells, among frequency resources shared by the plurality of cells; and notifying a processing device, which executes allocation of radio resources to each of the cells, of second information specifying the range of frequency resources, wherein the range of frequency resources is set such that a range of frequency resources that can be used preferentially by a first cell included in the plurality of cells is at least partially different from a range of frequency resources that can be used preferentially by a second cell included in the plurality of cells and different from the first cell.

3. The control device according to claim 1,
wherein the obtaining obtains information capable of specifying a utilization amount of radio resources or a traffic amount in the cells as the first information.

4. The control device according to claim 1,
wherein the setting specifies a ratio of a communication amount in each of the cells, and sets the range of frequency resources for each of the cells such that the range of frequency resources increases as the ratio of the communication amount increases.

5. The control device according to claim 4,
wherein as the first information, the obtaining obtains information capable of specifying an overall cell communication amount in each of the plurality of cells, and information capable of specifying a communication amount corresponding to a predetermined network slice in each of the plurality of cells, and
the setting: specifies a ratio of the overall cell communication amount in each of the plurality of cells, and determines an amount of the frequency resources to be set for each of the cells such that the range of frequency resources set for a cell increases as the ratio of the overall cell communication amount increases;specifies a communication amount corresponding to the predetermined network slice in each of the plurality of cells, and modifies the amount of the frequency resources set for each of the cells such that an amount of frequency resources to be added increases as the communication amount corresponding to the predetermined network slice increases; and sets the range of frequency resources for each of the cells using the modified amount of the frequency resources set for each of the cells.

6. The control device according to claim 4,
wherein as the first information, the obtaining obtains information capable of specifying an overall cell communication amount in each of the plurality of cells, and information capable of specifying a communication amount corresponding to a predetermined network slice in each of the plurality of cells, and
the setting: specifies the communication amount corresponding to the predetermined network slice in each of the plurality of cells, and performs a first determination for determining an amount of frequency resources to be set for each of the cells so as not to be less than an amount of radio resources necessary for communication of the communication amount corresponding to the predetermined network slice ;specifies a ratio of an overall cell communication amount in each of the plurality of cells, and performs a second determination for determining the amount of frequency resources to be set for each of the cells with respect to remaining frequency resources obtained by subtracting the amount of frequency resources determined in the first determination from an amount of the frequency resources shared, such that the range of frequency resources to be set for a cell increases as the ratio of the overall cell communication amount increases; and sets the range of frequency resources for each of the cells based on the amount of frequency resources to be set for each of the cells determined in each of the first determination and the second determination.

7. The control device according to claim 1,
wherein the setting further obtains an interference amount in each of the cells and, using the interference amount, sets a location, on a frequency axis, of the range of frequency resources allocated to each of the cells.

8. The control device according to claim 1,
wherein the notifying notifies a Distributed Unit in the O-RAN operating as the processing device of the second information.

9. A processing device in an Open-Radio Access Network (O-RAN), the processing device comprising: at least one memory that stores a set of instructions; and at least one processor that executes the instructions, the instructions, when executed, causing the processing device to perform operations comprising: providing first information pertaining to a communication amount in a first cell to a RAN Intelligent Controller (RIC) in the O-RAN, the first cell being included in a plurality of cells provided by the O-RAN and being associated with the processing device; obtaining second information indicating at least one of a lower end or an upper end of a range of frequency resources that can be used preferentially by the first cell among frequency resources shared by the plurality of cells, the second information being generated using the first information; and allocating radio resources to a wireless terminal that connects to the first cell, based on the second information,wherein the range of frequency resources that can be used preferentially by the first cell is set to be at least partially different from a frequency range that can be used preferentially by a second cell included in the plurality of cells and different from the first cell, andwhen allocating the radio resources to the wireless terminal that connects to the first cell, the allocating performs allocation such that radio resources included in a range of first frequency resources that can be used preferentially by the first cell are allocated preferentially over radio resources included in a range of second frequency resources different from the range of first frequency resources, among the frequency resources shared by the plurality of cells.

10. The processing device according to claim 9,
wherein in a case where the lower end of the range of frequency resources that can be used preferentially by the first cell is obtained as the second information, the allocating means allocates radio resources of frequencies higher than the lower end in an ascending order from a radio resource having a lowest frequency, and in a case where the upper end of the range of frequency resources that can be used preferentially by the first cell is obtained as the second information, the allocating allocates radio resources of frequencies lower than the upper end in a descending order from a radio resource having a highest frequency.

11. A processing device in an Open-Radio Access Network (O-RAN), the processing device comprising at least one memory that stores a set of instructions; and at least one processor that executes the instructions, the instructions, when executed, causing the processing device to perform operations comprising :providing first information pertaining to a communication amount in a first cell to a RAN Intelligent Controller (RIC) in the O-RAN, the first cell being included in a plurality of cells provided by the O-RAN and being associated with the processing device; obtaining second information specifying a range of frequency resources that can be used preferentially by the first cell among frequency resources shared by the plurality of cells, the second information being generated using the first information; and allocating radio resources to a wireless terminal that connects to the first cell, based on the second information, wherein the range of frequency resources that can be used preferentially by the first cell is set to be at least partially different from a frequency range that can be used preferentially by a second cell included in the plurality of cells and different from the first cell, and when allocating the radio resources to the wireless terminal that connects to the first cell, the allocating performs allocation such that radio resources included in a range of first frequency resources that can be used preferentially by the first cell are allocated preferentially over radio resources included in a range of second frequency resources different from the range of first frequency resources, among the frequency resources shared by the plurality of cells.

12. The processing device according to claim 9,
wherein in a frequency region, the allocating allocates, to communication corresponding to a predetermined network slice, radio resources that are included in the range of first frequency resources and not included in a predetermined frequency range of the first frequency resources, with preference over radio resources that are included in the predetermined frequency range in the range of first frequency resources, the predetermined frequency range being a range of the first frequency resources extending from a boundary between the range of first frequency resources and the range of second frequency resources.

13. The processing device according to claim 9,
wherein the providing provides a utilization amount of radio resources or a traffic amount in the first cell as the first information.

14. The processing device according to claim 9,
wherein the providing provides information capable of specifying a communication amount corresponding to a predetermined network slice in the cells as the first information.

15. A control method executed by a control device that functions as a RAN Intelligent Controller (RIC) in an Open-Radio Access Network (O-RAN), the control method comprising:obtaining first information pertaining to a communication amount in each of a plurality of cells provided by the O-RAN;setting, using the first information, a range of frequency resources that can be used preferentially by each of the cells, among frequency resources shared by the plurality of cells; andnotifying a processing device, which executes allocation of radio resources to each of the cells, of second information indicating at least one of a lower end or an upper end of the range of frequency resources,wherein in the setting, the range of frequency resources is set such that a range of frequency resources that can be used preferentially by a first cell included in the plurality of cells is at least partially different from a range of frequency resources that can be used preferentially by a second cell included in the plurality of cells and different from the first cell.

16. A processing method executed by a processing device in an Open-Radio Access Network (O-RAN), the processing method comprising:providing first information pertaining to a communication amount in a first cell to a RAN Intelligent Controller (RIC) in the O-RAN, the first cell being included in a plurality of cells provided by the O-RAN and being associated with the processing device;obtaining second information indicating at least one of a lower end or an upper end of a range of frequency resources that can be used preferentially by the first cell among frequency resources shared by the plurality of cells, the second information being generated using the first information; andallocating radio resources to a wireless terminal that connects to the first cell based on the second information,wherein the range of frequency resources that can be used preferentially by the first cell is set to be at least partially different from a frequency range that can be used preferentially by a second cell included in the plurality of cells and different from the first cell, andin the allocating, when allocating the radio resources to the wireless terminal that connects to the first cell, radio resources included in a range of first frequency resources that can be used preferentially by the first cell are allocated preferentially over radio resources included in a range of second frequency resources different from the range of first frequency resources, among the frequency resources shared by the plurality of cells.

17. A non-transitory computer-readable-storage medium that stores a program that causes, when the program is executed, a control device functioning as a RAN Intelligent Controller (RIC) in an Open-Radio Access Network (O-RAN) to performing obtaining first information pertaining to a communication amount in each of a plurality of cells provided by the O-RAN; setting, using the first information, a range of frequency resources that can be used preferentially by each of the cells, among frequency resources shared by the plurality of cells; notifying a processing device, which executes allocation of radio resources to each of the cells, of second information indicating at least one of a lower end or an upper end of the range of frequency resources; andseting the range of frequency resources such that a range of frequency resources that can be used preferentially by a first cell included in the plurality of cells is at least partially different from a range of frequency resources that can be used preferentially by a second cell included in the plurality of cells and different from the first cell.

18. A non-transitory computer-readable-storage medium that stores a program that causes, when the program is executed, a processing device in an Open-Radio Access Network (O-RAN) to perform: providing first information pertaining to a communication amount in a first cell to a RAN Intelligent Controller (RIC) in the O-RAN, the first cell being included in a plurality of cells provided by the O-RAN and being associated with the processing device; obtaining second information indicating at least one of a lower end or an upper end of a range of frequency resources that can be used preferentially by the first cell among frequency resources shared by the plurality of cells, the second information being generated using the first information; allocating radio resources to a wireless terminal that connects to the first cell based on the second information; setting the range of frequency resources that can be used preferentially by the first cell to be at least partially different from a frequency range that can be used preferentially by a second cell included in the plurality of cells and different from the first cell; and when allocating the radio resources to the wireless terminal that connects to the first cell, cause radio resources included in a range of first frequency resources that can be used preferentially by the first cell to be allocated preferentially over radio resources included in a range of second frequency resources different from the range of first frequency resources, among the frequency resources shared by the plurality of cells.
